(19) United States
(12) Patent Application Publication
(10) Pub. No.: US 2025/0369796 A1
(43) Pub. Date: Dec. 4, 2025

(54) REAL-TIME ESTIMATION OF ICE THICKNESS ON FIBER OPTIC CABLES USING HYBRID SIGNAL PROCESSIN DISTRIBUTED ACOUSTIC SENSING DATA

(71) Applicant: NEC Laboratories America, Inc., Princeton, NJ (US)

(72) Inventors: Yangmin DING, EAST BRUNSWICK, NJ (US); Yue TIAN, Princeton, NJ (US); Zhuocheng JIANG, PLAINSBORO, NJ (US); Sarper OZHARAR, Pennington, NJ (US); Ting WANG, West Windsor, NJ (US)

(73) Assignee: NEC Laboratories America, Inc., Princeton, NJ (US)

(21) Appl. No.: 19/220,085

(22) Filed: May 28, 2025

Related U.S. Application Data
(60) Provisional application No. 63/652,363, filed on May 28, 2024.

(51) Int. Cl. G01H 9/00

(52) U.S. Cl. CPC G01H 9/004

(57) ABSTRACT

Disclosed are systems and methods that employ distributed fiber optic sensing (DFOS)/distributed acoustic sensing (DAS) to monitor and provide real-time estimation of ice thickness on fiber optic communications facilities, and which integrate DSA data with a hybrid processing technique that combines frequency domain decomposition (FDD) and stochastic subspace identification (SSI). Aspects of our innovative systems and methods include: i) Hybrid Signal Processing Techniques; ii) Real-time, Continuous Ice Monitoring; iii) Enhanced Noise Robustness and Non-linear Dynamics Handling; and iv) Adaptability and Scalability.

### CROSS REFERENCE TO RELATED APPLICATIONS

This application claims the benefit of U.S. Provisional Patent Application Ser. No. 63/652,363 filed May 28, 2024, the entire contents of which is incorporated by reference as if set forth at length herein.

### FIELD OF THE INVENTION

This application relates generally to distributed fiber optic sensing (DFOS) systems, methods, and structures. More particularly, it pertains to improved DFOS/Distributed Acoustic Sensing (DAS) systems and methods for real-time estimation of ice thickness on fiber optic cables using hybrid signal processing of distributed acoustic sensing data.

### BACKGROUND OF THE INVENTION

As those skilled in the art will understand and appreciate, the ability to monitor the operating status, integrity, and threats to infrastructure—particularly telecommunications facilities—is a constant concern of utility companies and other service providers. As those skilled in the art will appreciate, the accumulation of ice on telecommunications optical fibers is one such threat to fiber optic communications.

### SUMMARY OF THE INVENTION

An advance in the art is made according to aspects of the present disclosure directed to systems and methods that employ distributed fiber optic sensing (DFOS)/distributed acoustic sensing (DAS) to monitor and provide real-time estimation of ice thickness on fiber optic communications facilities.

In sharp contrast to the prior art, systems and methods according to aspects of the present disclosure employ DAS and integrate DSA data with a hybrid processing technique that combines frequency domain decomposition (FDD) and stochastic subspace identification (SSI).

As we shall show and describe, our inventive systems and methods significantly advance the state of the art of ice monitoring by introducing several inventive features.

### Hybrid Signal Processing Technique

The fusion of FDD and SSI into a single, coherent analysis framework is unprecedented in the context of using DAS data for ice thickness estimation. While FDD excels in spectral analysis, identifying dominant frequencies affected by ice accumulation, SSI offers deep insights into the system's modal parameters from the time domain, including behaviors under non-linear dynamics and in the presence of noise. This combination ensures a holistic view of the cable's dynamic response to ice accumulation, enhancing the accuracy and reliability of ice thickness estimations beyond what either method could achieve alone. It also introduces a novel approach to data interpretation, enabling more nuanced understanding and prediction of ice-related risks.

### Real-time, Continuous Ice Monitoring

The application of DAS technology for continuous, real-time monitoring of ice accumulation on fiber optic cables, especially when analyzed with the hybrid FDD-SSI technique, sets a new benchmark in the field. This capability allows for the dynamic assessment of ice load a feature not fully realized in existing solutions. Continuous monitoring enables immediate detection and response to ice formation, greatly reducing the risk of cable damage or failure. This real-time capability ensures that infrastructure operators can take proactive measures to safeguard cables and maintain service integrity.

### Enhanced Noise Robustness and Non-linear Dynamics Handling

The hybrid approach's inherent robustness to environmental and operational noise, as well as its capacity to handle non-linear dynamics introduced by ice accumulation, represents a significant advancement. Traditional methods often struggle with these complexities, leading to inaccuracies in ice load estimation. By providing a more reliable analysis under varied and challenging conditions, the system enhances the safety and resilience of fiber optic networks, ensuring consistent performance and reducing maintenance costs.

### Adaptability and Scalability

The system's design allows for adaptability to various cable types, installation conditions, and environmental scenarios without the need for extensive customization. This adaptability, coupled with the system's scalability in processing capabilities, demonstrates an innovative step forward. The invention's versatility ensures its applicability across a wide geographic range and in diverse operational contexts, making it a universally applicable solution for ice thickness estimation on fiber optic cables

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing an illustrative fiber optic telecommunications infrastructure that is suspended from utility poles and interconnected with a DFOS/DAS for continuous monitoring/ice estimation according to aspects of the present disclosure.

FIG. 3 is a schematic flow diagram showing illustrative features of systems and methods according to aspects of the present disclosure and their relationship or sequence according to aspects of the present disclosure.

FIG. 4 is a schematic feature diagram in hierarchical format showing inventive features for systems and methods according to aspects of the present disclosure.

FIG. 5 is a schematic block diagram of an illustrative computer system in which aspects of the present disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

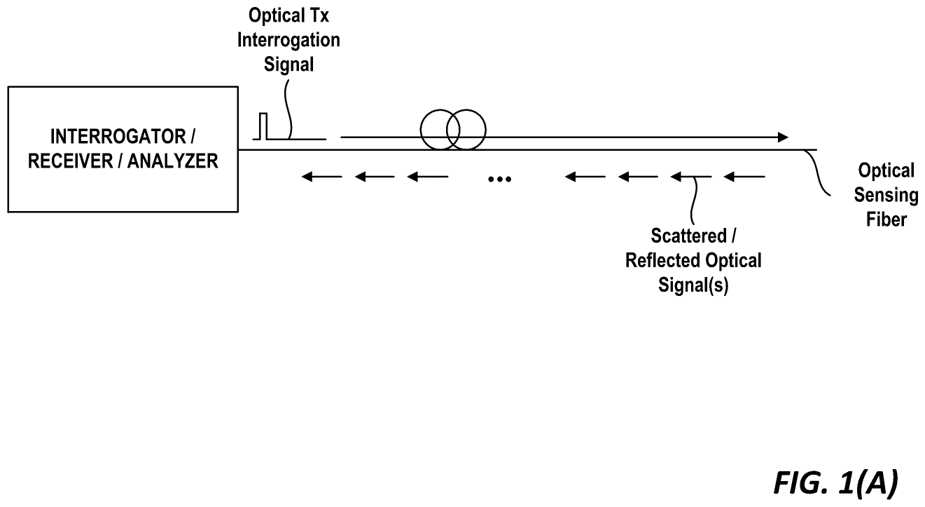

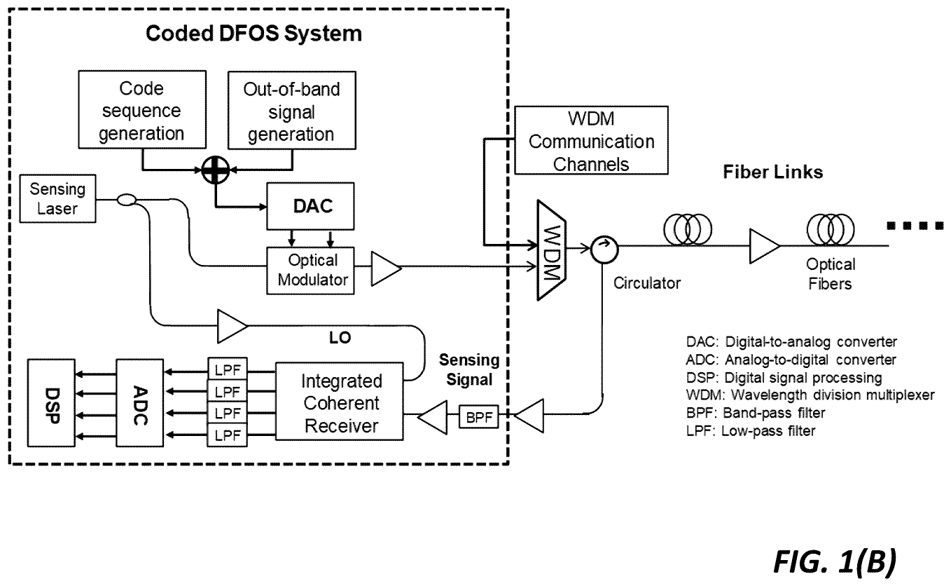

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyze reflected/backscattered and subsequently received signal(s). The signals received are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration or an indication of temperature.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered, and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

Systems and methods according to aspects of the present disclosure address several critical challenges in monitoring and managing ice accumulation on optic fiber cables, particularly those aerial fibers strung along power lines, which can significantly impact infrastructure reliability and safety. The primary problems this invention aims to solve include at least the following.

### Inaccurate Ice Thickness Estimation

Traditional methods for estimating ice thickness on cables often rely on direct observations or simple models that do not account for the complex dynamics of ice formation. These methods can lead to inaccurate estimations of ice load, either underestimating or overestimating the threat posed to the cables and associated structures. Inaccurate estimations can result in either unnecessary and costly interventions or insufficient responses that fail to prevent damage or service disruption.

### Non-Uniform Ice Accretion

Ice does not always form uniformly along a cable. Variations in environmental conditions such as temperature, wind speed, and humidity can lead to uneven ice accumulation, which presents significant challenges for estimation models based on the assumption of uniform accretion. Non-uniform ice formation can create localized stress points on the cables, increasing the risk of mechanical failure.

### Limited Detection Capabilities of Existing Monitoring Technologies

Many existing technologies and methodologies for monitoring ice load on cables are limited in their ability to detect subtle changes in the physical conditions of the cables that indicate ice formation. These limitations hinder timely and effective responses to mitigate the risks associated with ice accumulation.

### Complexity of Ice Formation Dynamics

The dynamics of ice formation on cables involve complex physical and environmental interactions that are difficult to model accurately. Traditional models may not account for the variability in ice properties, such as density and adherence to the cable surface, which can vary with environmental conditions and impact the effectiveness of ice load management strategies.

### Need for Real-time Monitoring and Adaptability

There is a growing need for real-time monitoring solutions that can adapt to changing conditions and provide accurate ice load estimations promptly. This capability is essential for ensuring the structural integrity and reliability of power line infrastructure under varying and often harsh environmental conditions

Our systems and methods according to the present disclosure introduce cutting-edge systems and methods for estimating ice thickness on fiber optic cables by harnessing the synergy of Distributed Acoustic Sensing (DAS) data analyzed through a novel hybrid approach that combines Frequency Domain Decomposition (FDD) and Stochastic Subspace Identification (SSI).

This innovative methodology capitalizes on the strengths of both FDD's spectral analysis capabilities and SSI's robustness in time-domain modal analysis, offering unparalleled accuracy and reliability in detecting and quantifying ice accumulation.

The integration of these advanced signal processing techniques enables the system to adeptly handle environmental noise and complex, non-linear dynamics associated with ice formation, significantly enhancing the precision of ice thickness estimations.

This hybrid approach represents a major leap forward in infrastructure monitoring technology, providing a comprehensive, real-time solution to the challenges of maintaining and ensuring the safety of fiber optic cable networks under adverse weather conditions

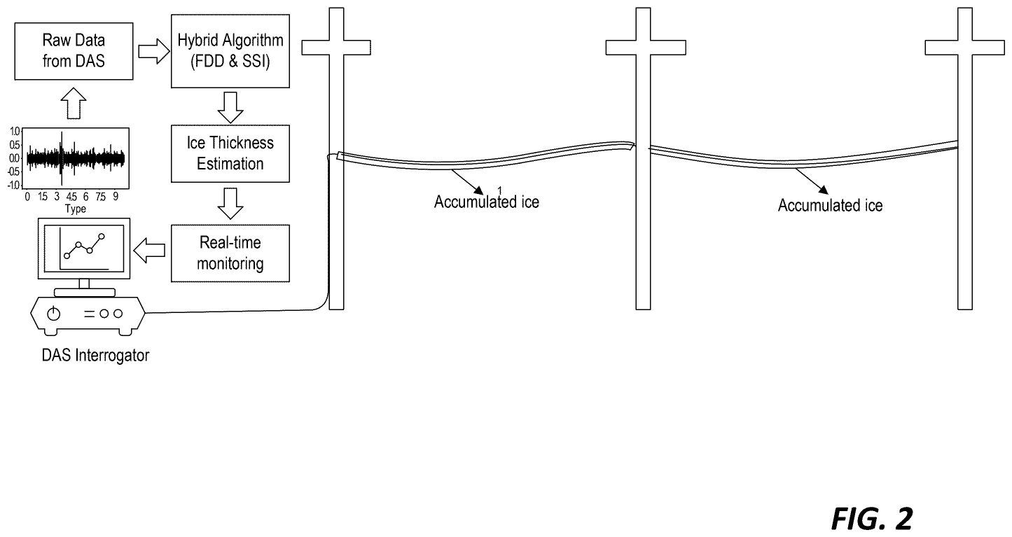

FIG. 2 is a schematic diagram showing an illustrative fiber optic telecommunications infrastructure that is suspended from utility poles and interconnected with a DFOS/DAS for continuous monitoring/ice estimation according to aspects of the present disclosure.

Our inventive systems and methods according to aspects of the present disclosure stand out for innovative approaches to estimating ice thickness on fiber optic cables, primarily through the integration of Distributed Acoustic Sensing (DAS) data with a hybrid signal processing technique that combines Frequency Domain Decomposition (FDD) and Stochastic Subspace Identification (SSI). This novel system and method introduces several inventive features that significantly advance the state of the art in ice monitoring.

### Hybrid Signal Processing Technique

The fusion of FDD and SSI into a single, coherent analysis framework is unprecedented in the context of using DAS data for ice thickness estimation. While FDD excels in spectral analysis, identifying dominant frequencies affected by ice accumulation, SSI offers deep insights into the system's modal parameters from the time domain, including behaviors under non-linear dynamics and in the presence of noise. This combination ensures a holistic view of the cable's dynamic response to ice accumulation, enhancing the accuracy and reliability of ice thickness estimations beyond what either method could achieve alone. It also introduces a novel approach to data interpretation, enabling more nuanced understanding and prediction of ice-related risks.

### Real-time, Continuous Ice Monitoring

The application of DAS technology for continuous, real-time monitoring of ice accumulation on fiber optic cables, especially when analyzed with the hybrid FDD-SSI technique, sets a new benchmark in the field. This capability allows for the dynamic assessment of ice load, a feature not fully realized in existing solutions. Continuous monitoring enables immediate detection and response to ice formation, greatly reducing the risk of cable damage or failure. This real-time capability ensures that infrastructure operators can take proactive measures to safeguard cables and maintain service integrity.

### Enhanced Noise Robustness and Non-Linear Dynamics Handling

The hybrid approach's inherent robustness to environmental and operational noise, as well as its capacity to handle non-linear dynamics introduced by ice accumulation, represents a significant advancement. Traditional methods often struggle with these complexities, leading to inaccuracies in ice load estimation. By providing a more reliable analysis under varied and challenging conditions, the system enhances the safety and resilience of fiber optic networks, ensuring consistent performance and reducing maintenance costs.

### Adaptability and Scalability

The system's design allows for adaptability to various cable types, installation conditions, and environmental scenarios without the need for extensive customization. This adaptability, coupled with the system's scalability in processing capabilities, demonstrates an innovative step forward. The invention's versatility ensures its applicability across a wide geographic range and in diverse operational contexts, making it a universally applicable solution for ice thickness estimation on fiber optic cables

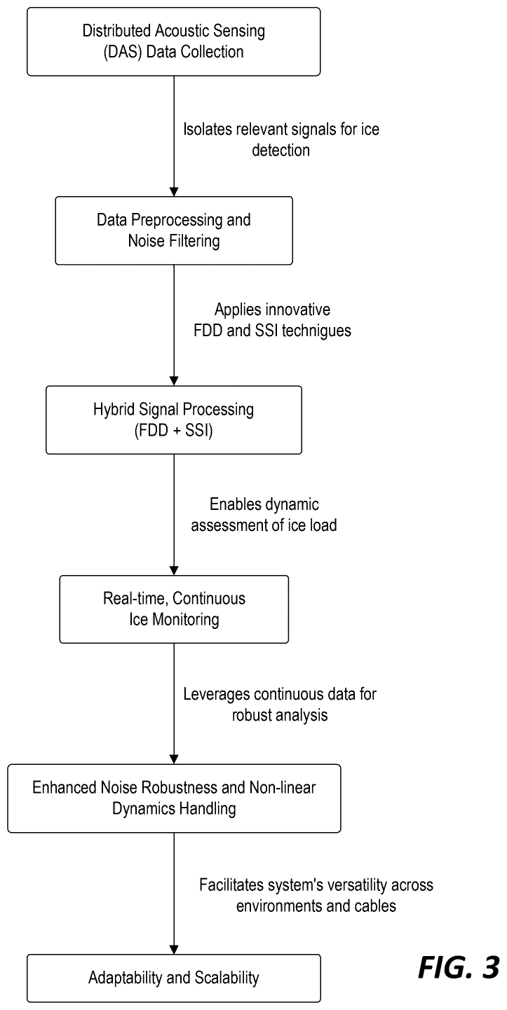

FIG. 3 is a schematic flow diagram showing illustrative features of systems and methods according to aspects of the present disclosure and their relationship or sequence according to aspects of the present disclosure.

Our inventive system, an advanced system for estimating ice thickness on fiber optic cables using DAS data analyzed through a hybrid approach of Frequency Domain Decomposition (FDD) and Stochastic Subspace Identification (SSI), can be described in the following step-by-step process.

### Step 1: Baseline Data Collection via DAS

Initially, we deploy DAS technology along fiber optic cables under known, ice-free conditions to collect baseline acoustic signals and vibrational patterns. This baseline data captures the normal operational state of the cables without the influence of ice, serving as a reference for detecting deviations caused by ice accumulation. This step will enable our system to differentiate between normal operational variations and those specifically induced by ice formation, enhancing the specificity and accuracy of ice detection.

### Step 2: Continuous Data Monitoring and Initial Data Processing

In this step, we continue to monitor the target cable with DAS technology to record acoustic signals during periods of potential ice accumulation. We will implement advanced filtering techniques, including machine learning algorithms, to preprocess the data. These algorithms compare incoming data against the baseline to identify deviations that signal ice accumulation. The intelligent preprocessing filters out irrelevant noise and focuses on deviations from the baseline, optimizing the system for detecting ice-induced changes with high precision.

### Step 3: Hybrid Signal Processing Technique

We apply a hybrid approach combining Frequency Domain Decomposition (FDD) and Stochastic Subspace Identification (SSI) to the preprocessed DAS data.

FDD Analysis: Converts the time-domain data into the frequency domain using Fourier transforms. Identify dominant frequencies where significant changes are observed, indicative of ice accumulation. FDD identifies shifts in the natural frequencies of the cable that are directly attributable to the added mass and stiffness from ice accumulation. These frequency shifts serve as primary indicators of the presence and extent of ice on the cable.

$$S ( f ) = {\int }_{- ∞}^{∞} s ( t ) {e}^{- j 2 π ft} dt$$

This equation calculates the spectral density S(f) at frequency f, where s(t) is the time-domain signal. SSI is applied to the same preprocessed DAS data, focusing on constructing a dynamic model of the cable's response to operational and environmental loading, including the impact of ice accumulation.

It involves estimating the system's modal parameters (e.g., frequencies, damping ratios) from the measured output data. By analyzing the changes in modal parameters, especially those affected by the additional mass of ice, SSI provides a detailed understanding of how ice affects the cable's dynamics. This method is particularly useful for capturing the effects of non-linear dynamics and complex ice accumulation patterns that FDD might not fully elucidate.

The basic state-space model used in SSI analysis is represented as:

$$x ( t + 1 ) = Ax ( t ) + Bu ( t ) \\ y ( t ) = Cx ( t ) + Du ( t )$$

These equations represent the state-space model in SSI, where x(t) and x(t+1) are the state vectors at consecutive times, A is the state transition matrix, B is the control matrix, u(t) is the input vector, y(t) is the output vector, C is the output matrix, and D is the feedforward matrix.

The integration of FDD and SSI offers a comprehensive analysis by combining the strengths of both techniques:

i) FDD quickly pinpoints changes in the spectral domain that suggest ice accumulation.

ii) SSI offers a deep dive into these changes, providing a detailed modal analysis that further refines the estimation of ice mass based on its impact on the cable's dynamic properties.

### Step 4: Ice Load Estimation

The estimation of ice load from the identified frequency shifts (via FDD) and modal parameter changes (via SSI) can leverage the fundamental principle that a change in the mass of a vibrating system (in this case, due to ice accumulation on a cable) affects its natural frequencies. The relationship is generally inverse; as the mass increases (due to ice), the natural frequencies decrease. One simplified approach to correlate these changes to ice load, considering the mass-spring model of a vibrating system, is to use the equation for the natural frequency of a mass-spring system:

$$f = \frac{1}{2 π} \sqrt{\frac{k}{m}}$$

Where f is the natural frequency of the system, k is the stiffness of the system, and m is the mass of the system.

$${F}_{ice} = α \cdot Δ f$$

Here, F_{ice} represents the estimated ice load, Δf is the observed change in natural frequency due to ice accumulation, and α is a proportionality constant that incorporates system characteristics, including stiffness and the initial mass of the cable system. The constant α would be determined through calibration with known loads or detailed modeling of the cable dynamics under ice accumulation.

### Step 5: Ice Thickness Calculation

Once the ice load F_{ice} is estimated, the next step is to convert this load into an ice thickness t_{ice}. Assuming the ice forms a uniform layer around the cable, the volume of ice can be related to the ice load by considering the density of ice ρ_{ice} and the affected length of the cable L. The ice thickness can be calculated by distributing this volume over the surface area it covers:

$${t}_{ice} = \frac{{F}_{ice}}{L \cdot w \cdot {ρ}_{ice}}$$

L and w represent the length and width over which the ice load is distributed

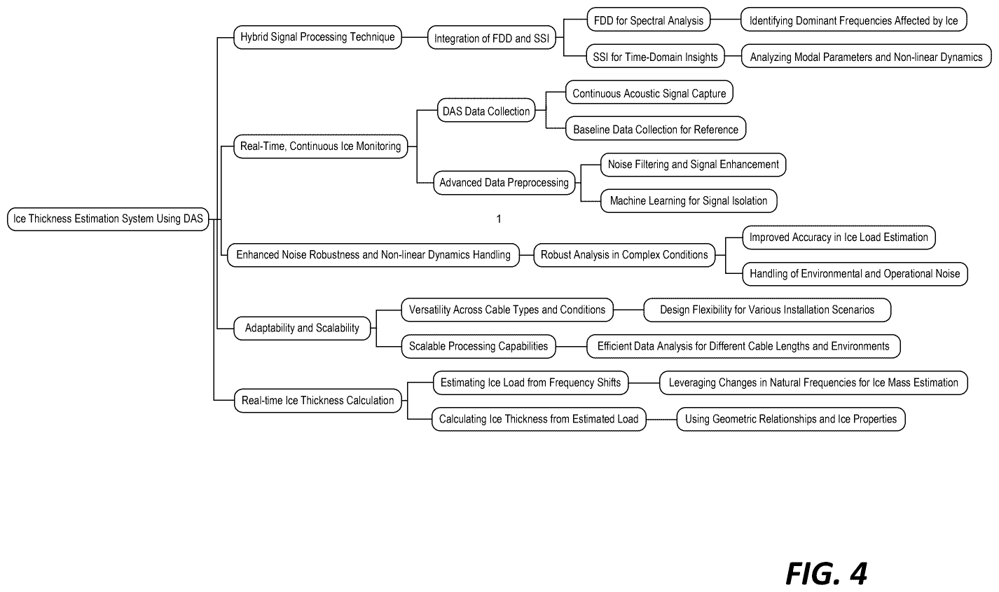

FIG. 4 is a schematic feature diagram in hierarchical format showing inventive features for systems and methods according to aspects of the present disclosure.

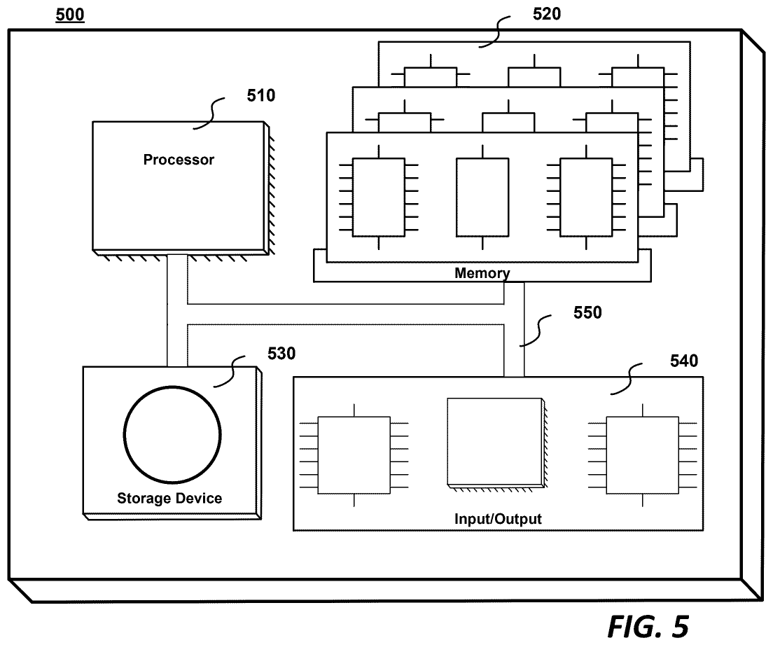

FIG. 5 is a schematic block diagram of an illustrative computer system in which aspects of the present disclosure may be executed to produce methods/algorithms according to aspects of the present disclosure.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 500 as stored program control instructions.

Computer system 500 includes processor 510, memory 520, storage device 530, and input/output structure 540. One or more input/output devices may include a display. One or more busses 550 typically interconnect the components, 510, 520, 530, and 540. Processor 510 may be a single or multicore. Additionally, the system may include accelerators etc., further comprising the system on a chip.

Processor 510 executes instructions in which embodiments of the present disclosure may comprise steps described in one or more of the Drawing figures. Such instructions may be stored in memory 520 or storage device 530. Data and/or information may be received and output using one or more input/output devices.

Memory 520 may store data and may be a computer-readable medium, such as volatile or non-volatile memory. Storage device 530 may provide storage for system 500 including for example, the previously described methods. In various aspects, storage device 530 may be a flash memory device, a disk drive, an optical disk device, or a tape device employing magnetic, optical, or other recording technologies.

Input/output structures 540 may provide input/output operations for system 500.

While we have presented our inventive concepts and description using specific examples, our invention is not so limited. Accordingly, the scope of our invention should be considered in view of the following claims.

1. A computer-implemented method providing real-time estimation of ice thickness fiber optic cables, the method comprising:
collecting baseline distributed fiber optic sensing (DFOS)/distributed acoustic sensing (DAS) data from a fiber optic sensor cable,
continuously collecting and preprocessing DFOS/DAS data during periods of potential ice accumulation,
applying a hybrid signal processing technique to the preprocessed DFOS/DAS data,
determining, from the hybrid signal processed DFOS/DAS data, an estimation of ice load on the fiber optic sensor cable, and
determining, using the estimation of ice load, an ice thickness estimation and providing an output of that determined ice thickness estimation.

2. The method of claim 1 wherein the baseline DFOS/DAS data includes baseline acoustic signals and vibration patterns without influence of ice.

3. The method of claim 2 wherein the preprocessing of the DFOS/DAS data includes filtering and machine learning techniques to compare incoming data against baseline data and identify deviations that signal ice accumulation.

4. The method of claim 3 wherein the hybrid signal processing technique combines frequency domain decomposition (FDD) and stochastic subspace identification (SSI) analysis.

5. The method of claim 4 wherein the FDD analysis converts time domain data into frequency domain data using Fourier transforms and identifies dominant frequencies where changes are observed, indicative of ice accumulation.

6. The method of claim 5 wherein the SSI analysis estimates system modal parameters including frequencies and damping ratios and analyzes changes in modal parameters affected by additional ice mass on the fiber optic sensor cable.

7. The method of claim 6 wherein the ice load estimation is determined using a change in mass of the fiber optic sensor cable due to ice load and the change in mass affect on vibrations of the fiber optic sensor cable.
